(19) United States
(12) Patent Application Publication
(10) Pub. No.: US 2018/0184207 A1
(43) Pub. Date: Jun. 28, 2018

(54) VIBRATING DIAPHRAGM

(71) Applicant: SHENZHEN VOICE TECHNOLOGY CO., LTD, Shenzhen, Guangdong (CN)

(72) Inventors: Hongbo WANG, Shenzhen, Guangdong (CN); Jun LI, Shenzhen, Guangdong (CN)

(73) Assignee: SHENZHEN VOICE TECHNOLOGY CO., LTD, Shenzhen, Guangdong (CN)

(21) Appl. No.: 15/309,692

(22) PCT Filed: Aug. 23, 2016
(86) PCT No.: PCT/CN2016/096396

§ 371 Date: Nov. 8, 2016

(51) Int. Cl. H04R 7/04

(52) U.S. Cl. CPC H04R 7/04

(57) ABSTRACT

The present invention discloses a vibrating diaphragm, comprising a middle portion, a folded ring portion and an edge portion which are connected in turn from the inside to the outside. The folded ring portion comprises at least two folded rings. The at least two folded rings are equal in width. Adjacent folded rings are tangent to each other and face opposite directions. The equal-width folded ring structure greatly reduces the asymmetry of the folded rings in the vibrating directions and ensures that the rigidity of the vibrating system is approximate in the positive and negative directions, thus reducing the non-linear characteristics of the structure and aiding in reduction of the THD (Total Harmonic Distortion) of a transducer.

### TECHNICAL FIELD

The present invention relates to the technical field of electroacoustic products, in particular to a vibrating diaphragm.

### DESCRIPTION OF THE RELATED ART

As science and technology develop continuously, design pursuits of electronic devices such as mobile phones and tablet computers become higher and higher, and the electronic devices get thinner and thinner, so the space reserved for installing a transducer becomes smaller gradually. However, people impose higher and higher requirements for tone quality. THD (Total Harmonic Distortion) is an important index for evaluating the properties of micro transducers. The non-linear characteristics of a system are the main factors affecting the THD. A vibrating diaphragm structure which is not symmetric in the vibrating direction directly causes a rise in the non-linearity of a rigidity curve and an increase in the THD, so the transducer has poor properties.

At present, traditional transducers mainly include two structures as shown in FIG. 1 and FIG. 2. The asymmetry of the two structures in the vibrating direction intensifies the asymmetry of the rigidity curve, so it is probable to increase the THD.

Aiming at the above problems, as shown in FIG. 3, a patent application, application No. 201521133832.7, discloses a vibrating diaphragm, with an invention point that a main folded ring is provided with a main folded ring reinforcing pattern area and an auxiliary folded ring is provided with an auxiliary folded ring reinforcing pattern area. By setting the reinforcing pattern areas, the purpose of reducing the THD is fulfilled. The technical solution of the patent application reduces the THD to a certain degree, but the effect is not desirable.

### Detailed Contents of the Invention

The technical problem to be solved in the present invention is to provide a vibrating diaphragm favorable for reducing THD.

In order to solve the above technical problems, the present invention employs the following technical solution. A vibrating diaphragm comprises a middle portion, a folded ring portion and an edge portion which are connected in turn from the inside to the outside; the folded ring portion comprises a first folded ring and a second folded ring; the first folded ring is as wide as the second folded ring; and the first folded ring and the second folded ring are tangent to each other and face opposite directions.

The present invention has the beneficial effect that the equal-width folded ring structure greatly reduces the asymmetry of the folded rings in the vibrating directions and ensures that the rigidity of the vibrating system is approximate in the positive and negative directions, thus reducing the non-linear characteristics of the structure and aiding in reduction of the THD of a transducer.

### DESCRIPTION OF SEVERAL VIEWS OF THE ATTACHED DRAWINGS

FIG. 1 is a sectional view of a vibrating diaphragm in the prior art.

FIG. 2 is a sectional view of another vibrating diaphragm in the prior art.

FIG. 3 is a sectional view of another vibrating diaphragm in the prior art.

FIG. 4 is a space diagram of embodiment 1 of the present invention.

FIG. 5 is a sectional view of a first vibrating diaphragm installed in a first assembling way according to embodiment 1 of the present invention.

FIG. 6 is a sectional view of the first vibrating diaphragm installed in a second assembling way according to embodiment 1 of the present invention.

FIG. 7 is a sectional view of a second vibrating diaphragm installed in the first assembling way according to embodiment 1 of the present invention.

FIG. 8 is a sectional view of the second vibrating diaphragm installed in the second assembling way according to embodiment 1 of the present invention.

FIG. 9 is a sectional view of a third vibrating diaphragm installed in the first assembling way according to embodiment 1 of the present invention.

FIG. 10 is a sectional view of the third vibrating diaphragm installed in the second assembling way according to embodiment 1 of the present invention.

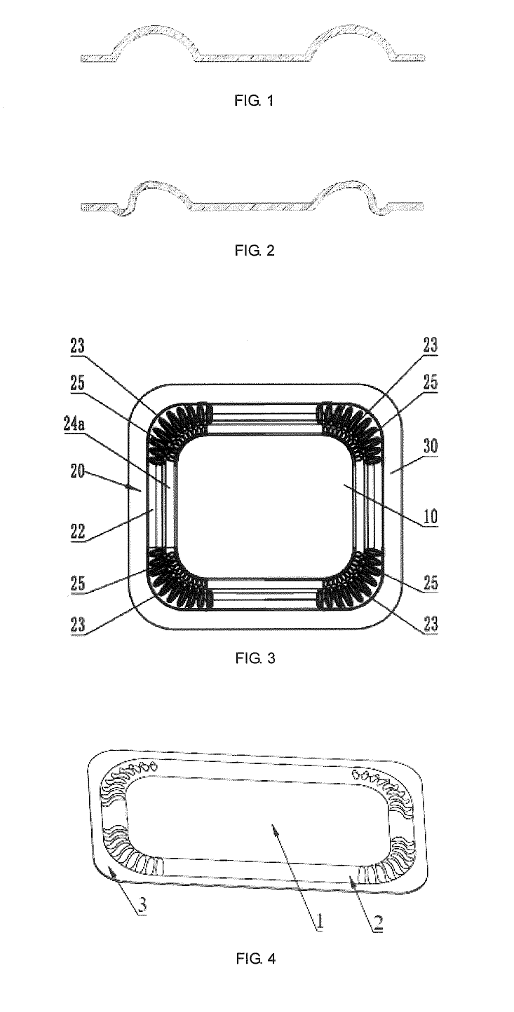

### DESCRIPTION OF MARKS

Middle portion—1;
Folded ring portion—2;
Edge portion—3;
First folded ring—21;
Second folded ring —22.

### DETAILED DESCRIPTION OF THE PRESENT INVENTION

The technical contents, fulfilled objective and effects of the present invention are described in detail with reference to the embodiments and attached drawings.

The key concept of the present invention lies in that the folded rings of a folded ring portion are set to be equal in width and adjacent folded rings are tangent to each other.

Refer to FIGS. 4-10. A vibrating diaphragm, comprising a middle portion, a folded ring portion and an edge portion which are connected in turn from the inside to the outside. The folded ring portion comprises a first folded ring and a second folded ring. The first folded ring is as wide as the second folded ring. The first folded ring and the second folded ring are tangent to each other and face opposite directions.

From the above description it can be known that the present invention has the beneficial effect that the equal-width folded ring structure greatly reduces the asymmetry of the folded rings in the vibrating directions and ensures that the rigidity of a vibrating system is approximate in positive and negative directions, thus reducing the non-linear characteristics of the structure and aiding in reduction of the THD of a transducer.

Further, the folded ring portion also comprises a third folded ring; the third folded ring is as wide as the second folded ring; and the third folded ring and the second folded ring are tangent to each other and face opposite directions.

Further, the folded ring portion also comprises a fourth folded ring; the fourth folded ring is as wide as the third folded ring; and the fourth folded ring and the third folded ring are tangent to each other and face opposite directions.

Further, the folded ring portion comprises at least five folded rings; the at least five folded rings are equal in width; adjacent folded rings are tangent to each other and face opposite directions.

From the above description it can be known that the folded ring portion can have a plurality of folded rings.

Further, the folded ring section of the folded ring portion is shaped as a semi-round ring or as a semi-oval ring or other shape.

### Embodiment 1

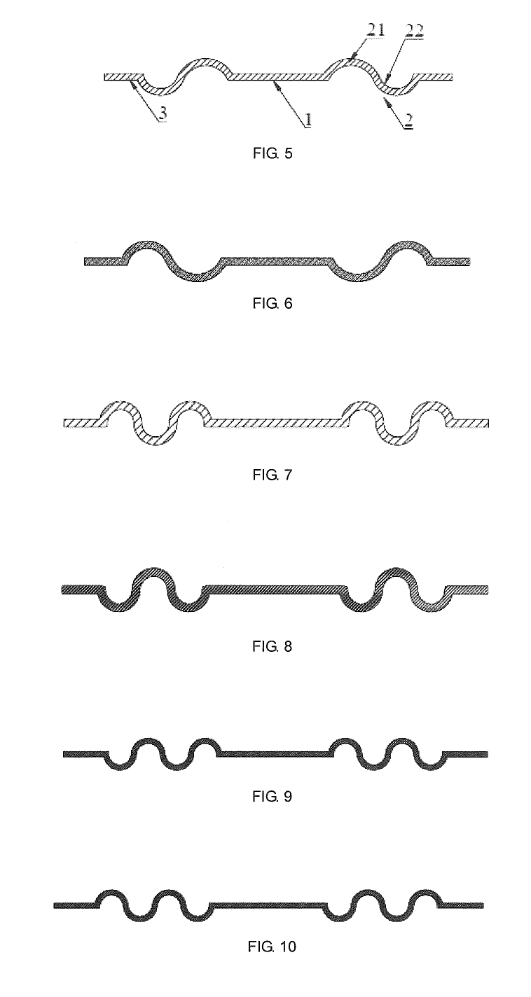

As shown in FIGS. 4-10, Embodiment 1 of the present invention is as follows. As shown in FIGS. 4-6, a vibrating diaphragm includes a middle portion 1, a folded ring portion 2 and an edge portion 3 which are connected in turn from the inside to the outside. The folded ring portion 2 includes a first folded ring 21 and a second folded ring 22. The first folded ring 21 and the second folded ring 22 are equal in width (in the figures, the openings of the folded rings are equal in length in the horizontal direction). The first folded ring 21 and the second folded ring 22 are tangent to each other and face opposite directions. By using an equal-width folded ring structure, the asymmetry of the folded rings is greatly reduced in the vibrating directions, and the rigidity of a vibrating system is approximate in the positive and negative directions, thus reducing the non-linear characteristics of the structure and aiding in reduction of the THD of a transducer. It should be understood that the vibrating diaphragm structures shown in FIG. 5 and FIG. 6 are the same. The two figures for illustration are used to explain that the vibrating diaphragm can be assembled in two ways, which means that after the vibrating diaphragm is installed on a transducer, the opening of the first folded ring of the vibrating diaphragm can both face the transducer and have its back to the transducer.

The folded ring section of the folded ring portion 2 is shaped as a semi-round ring or a semi-oval ring or other shape. In this embodiment, the folded ring section of the folded ring portion 2 is shaped as a semi-round ring.

Further, as shown in FIG. 7 and FIG. 8, the folded ring portion also comprises a third folded ring; the third folded ring is as wide as the second folded ring; and the third folded ring and the second folded ring are tangent to each other and face opposite directions. Further, as shown in FIG. 9 and FIG. 10, the folded ring portion also comprises a fourth folded ring; the fourth folded ring is as wide as the third folded ring; and the fourth folded ring and the third folded ring are tangent to each other and face opposite directions. As an improvement, the folded ring portion comprises at least five folded rings; the at least five folded rings are equal in width; adjacent folded rings are tangent to each other and face opposite directions.

In conclusion, the vibrating diaphragm provided by the present invention, by using an equal-width folded ring structure, greatly reduces the asymmetry of the folded rings in the vibrating directions, and ensures that the rigidity of the vibrating system is approximate in the positive and negative directions, thus reducing the non-linear characteristics of the structure and aiding in reduction of the THD of a transducer.

The above are only some embodiments of the present invention and shall not be regarded as limits to the present invention. Any equivalent modifications made on the basis of the description and attached drawings of the present invention, or director or indirect application to the related fields, shall fall within the protective scope of the present invention.

### Technical Problems

### Solution

### Beneficial Effects of the Present Invention

1. A vibrating diaphragm, comprising a middle portion, a folded ring portion and an edge portion which are connected in turn from the inside to the outside, characterized in that the folded ring portion comprises a first folded ring and a second folded ring; the first folded ring is as wide as the second folded ring; and the first folded ring and the second folded ring are tangent to each other and face opposite directions.

2. The vibrating diaphragm according to claim 1, wherein the folded ring portion also comprises a third folded ring; the third folded ring is as wide as the second folded ring; and the third folded ring and the second folded ring are tangent to each other and face opposite directions.

3. The vibrating diaphragm according to claim 2, wherein the folded ring portion also comprises a fourth folded ring; the fourth folded ring is as wide as the third folded ring; and the fourth folded ring and the third folded ring are tangent to each other and face opposite directions.

4. The vibrating diaphragm according to claim 1, wherein the folded ring portion comprises at least five folded rings; the at least five folded rings are equal in width; adjacent folded rings are tangent to each other and face opposite directions.

5. The vibrating diaphragm according to any one of claims 1-5, wherein the folded ring section of the folded ring portion is shaped as a semi-round ring or as a semi-oval ring or other shape.
